(19) United States
(12) Patent Application Publication
(10) Pub. No.: US 2006/0110091 A1
(43) Pub. Date: May 25, 2006

(54) Semiconductor optical waveguide device

(75) Inventor: Ian Edward Day, Oxford (GB)

Correspondence Address: LAHIVE & COCKFIELD, 28 STATE STREET, BOSTON, MA, 02109, US

(73) Assignee: Bookham Technology, PLC, Towcester (GB)

(21) Appl. No.: 10/521,227

(22) PCT Filed: Jul. 8, 2003
(86) PCT No.: PCT/GB03/02949

§ 371 Date: Sep. 6, 2005

(30) Foreign Application Priority Data
Jul. 12, 2002 (GB) 0216143..8

(51) Int. Cl. G02F 1/295; G02B 6/10; G02B 6/26

(52) U.S. Cl. 385/8; 385/40; 385/132

(57) ABSTRACT

A semiconductor optical wave guide device (1) comprising a semiconductor layer (3) having an upper surface (5), and a lower surface (7) which is defined by a lower confinement layer(9), the semiconduct or layer having formed therein: (a) a wave guide (13); (b) at least one recess (19) adjacent to the waveguide (13)and extending from the upper surface (5)of the semiconductor layer (3); (c) at least one doped region (21, 23), at least part of which is situated between a said recess (19) and the lower confinement layer (9); and (d) at least one trench (25) adjacent to a said doped region (21, 23) and recess (19) and situated on an opposite side thereof to the waveguide, wherein the (or each) trench (25) extends from the upper surface of the semiconductor layer (3).

The present invention relates to semiconductor optical waveguide devices, and particularly to their use in electro-optic modulators.

Semiconductor optical waveguide devices in which the semiconductor material is doped to produce p and/or n doped regions are very well known. For example, semiconductor rib waveguide devices are known in which a P-i-n diode is formed across the waveguide such that charge carriers are injected into the region of the waveguide in which an optical wave propagates (during use). The p-i-n diode therefore acts as an electro-optic modulator since the injection of charge carriers into the semiconductor waveguide affects the complex effective refractive index of the waveguide, and thereby affects the phase and amplitude of the optical wave propagating therein.

P. D. Hewitt and G. T. Reed of the Department of Electrical and Electronic Engineering, University of Surrey, UK, have reported (in the Journal of Lightwave Technology, Vol. 19, No. 3, March 2001) a mathematical simulation study of a silicon rib waveguide p-i-n modulator envisaged to comprise “lateral” n+ and p+ doped regions on opposite sides of the rib, and a p+ a “top” doped region on the rib. A vertical trench comprising silica is provided in the silicon (of the simulated modulator) adjacent to each lateral doped region, on: the opposite side of the adjacent region to the rib waveguide. The authors of the paper reported that the closer each vertical trench is to its respective lateral doped region, the greater is the refractive index change (for a particular current density) of the waveguide between the lateral doped regions. This dependence of the refractive index change on the position of the vertical trenches is ascribed by the authors to the presence of free carriers on opposite sides of the lateral doped regions to that of the rib waveguide.

International Patent Application No. PCT/GB99/02537 published as WO 00/10039 (Bookham Technology), which pre-dates the reporting of the above simulation study, discloses a lateral doped silicon rib waveguide modulator of similar construction to that envisaged in the simulation study (but without the “top” doping on the rib of the waveguide) with the vertical trenches immediately adjacent to the lateral doped regions.

The inventors of the present invention have now devised a type of novel and inventive semiconductor optical waveguide device which enables p-i-n modulators with significantly improved operating performance to be fabricated.

According to a first aspect, the present invention provides a semiconductor optical waveguide device comprising a semiconductor layer having an upper surface, and a lower surface which is defined by a lower confinement layer, the semiconductor layer having formed therein:
(a) a waveguide;
(b) at least one recess adjacent to the waveguide and extending from the upper surface of the semiconductor layer;
(c) at least one doped region, at least part of which is situated between a said recess and the lower confinement layer; and
(d) at least one trench adjacent to a said doped region and recess and situated on an opposite side thereof to the waveguide, wherein the (or each) trench extends from the upper surface of the semiconductor layer.

Preferably the (or each) trench of the device is deeper than its adjacent recess.

In some embodiments of the invention, the (or each) recess is spaced apart from its adjacent trench. In alternative embodiments of the invention, the (or each) recess is not spaced apart from its adjacent trench, so that the recess and trench comprise a single larger feature.

Advantageously, the (or each) doped region may extend substantially to the lower confinement layer.

According to a second aspect, the invention provides a semiconductor optical waveguide device comprising a semiconductor layer having an upper surface, and a lower surface which is defined by a lower confinement layer, the semiconductor layer having formed therein:
(a) a waveguide;
(b) at least one doped region extending substantially to the lower confinement layer; and
(c) at least one trench adjacent to, and spaced apart from, a said doped region and situated on an opposite side thereof to the waveguide, wherein the (or each) trench extends from the upper surface of the semiconductor layer.

In preferred embodiments of both aspects of the invention, the (or each) trench extends substantially to the lower confinement layer.

The combination of (on one hand) the trench(es) and (on the other hand) the recess(es) and/or the extension of the doped region(s) to the confinement layer has been found by the inventors to result in vastly improved confinement of the free electrical charge carriers. Such improved confinement of the charge carriers leads to a significant improvement in the efficiency of devices in accordance with the invention in comparison to known devices. While not wishing to be limited by any particular theory, the inventors believe that a combination of lateral and vertical charge carrier confinement (which the present invention can provide) is synergistic and results in greater improvements in device, efficiency than might have been expected in hindsight.

The confinement layer preferably is a confinement layer for electrical charge carriers (i.e. it confines the electrical charge carriers). Advantageously, the confinement layer may also be an optical confinement layer (i.e. it may confine the optical mode propagated by the waveguide).

Preferably the semiconductor layer comprises silicon (especially crystalline silicon). The lower confinement layer preferably is an electrically insulating layer. Advantageously, therefore, the device may be a silicon-on-insulator (SOI) device. The lower confinement layer therefore preferably comprises silica. Preferably there is a substrate layer below the lower confinement layer. The substrate layer preferably comprises silicon.

The terms “upper”, “lower”, “above”, “below”, etc. used in this specification are not intended to denote any absolute orientation, but relative positions with respect to the waveguide and the confinement layer. By “lateral” is generally meant substantially perpendicular to the length of the waveguide and substantially parallel to the lower confinement layer.

The waveguide of the device according to the invention preferably is a rib waveguide. The rib waveguide preferably comprises an elongate rib portion and slab regions on immediately adjacent opposite lateral sides of the rib portion, the rib portion projecting above the slab regions. The slab regions of the waveguide generally do not have a definite lateral boundary; the extent to which the optical mode spreads laterally into the slab regions is normally determined primarily by its confinement by the rib portion and the lower confinement layer. The (or each) doped region, trench and (where present) recess preferably is situated in a slab region of the device which comprises a continuous lateral extension of the slab region of the waveguide. In fact, the (or each) doped region (and recess, where present) may form part of the slab region of the waveguide itself because there may be some overlap between the optical mode and the (or each) doped region. Such overlapping is, however, generally undesirable since it causes optical attenuation, and hence it is preferably minimal.

The, or each, trench of the device may be left open (with or without one or more protective layers, e.g. of silica). Alternatively, the trench (es) may be partially or completely filled with a material different to that of the semiconductor layer, e.g. silica, amorphous silicon, or some other deposit (s).

Devices according to the invention may be formed by known semiconductor device fabrication techniques, including photolithography and etching of the semiconductor layer to fabricate the various features formed therein.

Embodiments of the invention will now be described, by way of example, with reference to the accompanying drawings, of which:

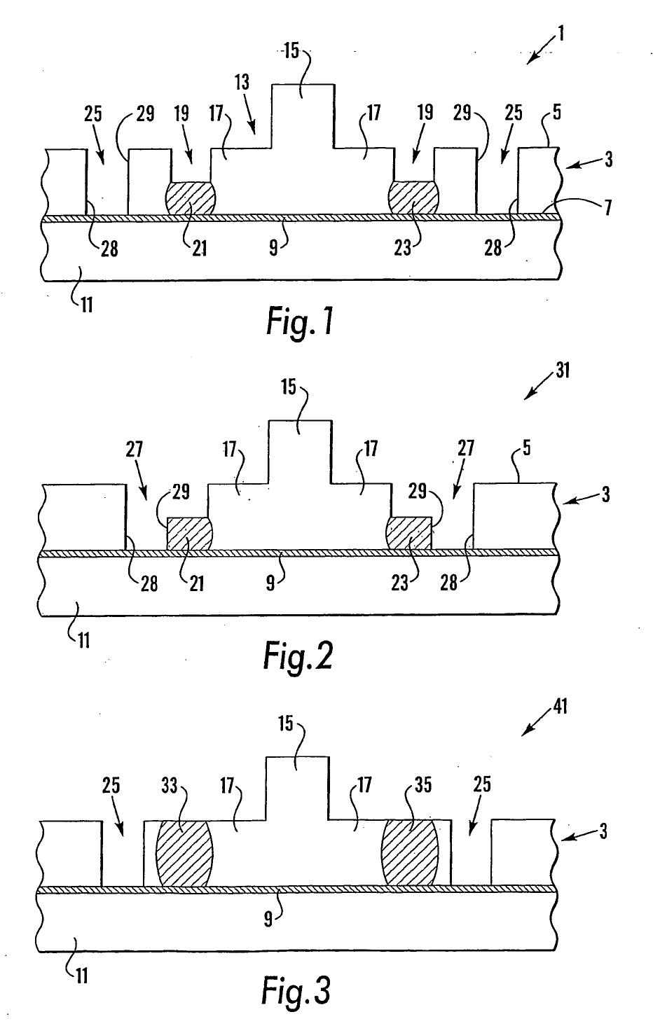

FIG. 1 is a schematic cross-sectional view of a first embodiment of a semiconductor optical waveguide device according to the invention;

FIG. 2 is a schematic cross-sectional view of second embodiment of a semiconductor optical waveguide device according to the invention; and

FIG. 3 is a schematic cross-sectional view of a third embodiment of a semiconductor optical waveguide device according to the invention.

FIG. 1 shows, in schematic cross-section, an embodiment of a semiconductor optical waveguide device 1 according to the invention. The device comprises a semiconductor layer 3 (comprising crystalline silicon) having an upper surface 5 and a lower surface 7 which is defined by a lower confinement layer 9. The lower confinement layer is a layer of silica, and below this is a substrate layer 11 of silicon.

The semiconductor layer 3 has formed therein a rib waveguide 13 comprising a rib portion 15 and slab regions 17 on opposite lateral sides of the rib portion; the rib portion 15 projects above the slab regions 17. The semiconductor layer 3 also includes a pair of recesses 19 on opposite lateral sides of the waveguide 13 (i.e. each recess being situated adjacent to a respective lateral side of the waveguide). The recesses 19 each extend from the upper surface 5 of the semiconductor layer downwardly towards the lower confinement layer 9, but spaced apart from the confinement layer. Also provided in the semiconductor layer 3 are doped regions 21 and 23 of the semiconductor material. Each doped region is situated between a respective recess 19 and the lower confinement layer 9, and extends from the recess to the confinement layer. The doped regions (which are termed “lateral” doped regions) are formed by doping in a direction from the bases of the recesses towards the lower confinement layer, e.g. by ion implantation and/or diffusion. Doped region 21 is an n-doped (e.g. n+- doped) region, and region 23 is a p-doped (e.g. p+-doped) region. Consequently the device comprises a lateral doped p-i-n diode, which preferably functions as a modulator (the waveguide region being an intrinsic semiconductor region between laterally situated n- and p-doped regions).

Although this is not illustrated in the figures, devices according to the invention may additionally include one or more “top” doped regions, e.g. a doped region of the rib portion 15 of the waveguide. Alternatively, devices according to the invention may comprise a single lateral doped region 21 or 23 and at least one top doped region, e.g. a doped region of the rib portion of the waveguide.

The semiconductor layer 3 of the device illustrated in FIG. 1 also includes a pair of trenches 25. Each trench 25 is adjacent to, and laterally spaced apart from a respective doped region and associated recess and is situated on an opposite lateral side of the doped region and recess to that of the waveguide. Each trench 25, extends from the upper surface 5 of the semiconductor layer to the lower confinement layer 9, and is defined by two sidewalls (i.e. an outer sidewall 28 and an inner sidewall 29). The trenches consequently provide lateral confinement of the free electrical charge carriers present in the semiconductor layer by virtue of the doped regions. The lower confinement layer also provides vertical confinement of the charge carriers, and these two types of confinement in combination have been found to result in a particularly efficient p-i-n diode arrangement.

FIG. 2 shows, schematically a device 31 according to the invention which is identical to that shown in FIG. 1 (with like features having the same reference numerals) except that in this case each trench 25 is not spaced apart from its adjacent recess 19 so that there is no laterally outer wall of the recess (or, put differently, the laterally outer wall of the trench has become the laterally outer wall of its adjacent recess). Consequently each recess and adjacent trench comprise a single larger feature, designated by reference numeral 27. In the FIG. 2 embodiment, the doped regions 21 and 23 are bounded not only by the base of their respective recess 19 and the lower confinement layer 9, but also by the inner sidewall 29 of their respective trench 25. This embodiment consequently provides the greatest degree of confinement to the electrical charge carriers supplied by the doped regions, and hence the greatest increase in efficiency.

The closer a trench is positioned to its respective doped region, the greater is the confinement of the charge carriers supplied by that doped region. The extreme of this is illustrated (as described above) in the example of FIG. 2 in which there is no separation between the (or each) french and its respective doped region.

FIG. 3 discloses a third embodiment of the invention, which is in accordance with the second aspect of the invention. This embodiment is similar to that shown in FIG. 1, except that in this case the device 41 does not include any recesses 19. Instead, the doped regions 33 and 35 extend from the upper surface 5 of the slab regions 17 on opposite sides of the rib portion 15. The doped regions 33 and 35 extend to the lower confinement layer 9.

1. A semiconductor optical waveguide device, comprising a semiconductor layer having an upper surface, and a lower surface which is defined by a lower confinement layer, the semiconductor layer having formed therein:
(a) a waveguide;
(b) at least one recess adjacent to the waveguide and extending from the upper surface of the semiconductor layer;
(c) at least one doped region, at least part of which is situated between the recess and the lower confinement layer; and
(d) at least one trench adjacent to the doped region and the recess and situated on an opposite side thereof to the waveguide, wherein the trench extends from the upper surface of the semiconductor layer.

2. A device according to claim 1, wherein the trench is deeper than the adjacent recess.

3. A device according to claim 1, wherein the recess is spaced apart from the adjacent trench.

4. A device according to claim 1, wherein the recess is not spaced apart from the adjacent trench, so that the recess and the trench comprise a single larger feature.

5. A device according to claim 1, wherein the doped region extends substantially to the lower confinement layer.

6. A semiconductor optical waveguide device, comprising a semiconductor layer having an upper surface, and a lower surface which is defined by a lower confinement layer, the semiconductor layer having formed therein:
(a) a waveguide;
(b) at least one doped region extending substantially to the lower confinement layer; and
(c) at least one trench adjacent to, and spaced apart from, the doped region and situated on an opposite side thereof to the waveguide, wherein the trench extends from the upper surface of the semiconductor layer.

7. A device according to claim 6, wherein the trench extends substantially to the lower confinement layer.

8. A device according to claim 6, wherein the waveguide is a rib waveguide, having a rib portion.

9. A device according to claim 6, wherein the semiconductor layer comprises silicon.

10. A device according to claim 6, wherein the lower confinement layer is a confinement layer for electrical charge carriers.

11. A device according to claim 6, wherein the lower confinement layer is a confinement layer for an optical mode propagated by the waveguide.

12. A device according to claim 6, wherein the lower confinement layer is an electrically insulating layer.

13. A device according claim 6, wherein the lower confinement layer comprises silica.

14. A device according to claim 6, further comprising a substrate layer below the lower confinement layer.

15. A device according to claim 14, wherein the substrate layer comprises silicon.

16. A device according to claim 6, further comprising two of said doped regions, the doped regions being situated on opposite sides of the waveguide.

17. (canceled)

18. (canceled)

19. A device according to claim 8, further comprising an additional doped region situated in the rib portion of the rib waveguide.

20. A device according to claim 6, further comprising two of said trenches, the trenches being situated on opposite sides of the waveguide.

21. A device according to claim 16, wherein the doped regions comprise n-doped and p-doped regions.

22. A device according to claim 6, further comprising a p-i-n diode.

23. A device according to claim 22, wherein the p-i-n diode comprises a lateral p-i-n diode.

24. A device according to claim 6, further comprising an optical modulator.

25. (canceled)

26. (canceled)

27. A device according to claim 2, further comprising two of said recesses, the recesses being situated on opposite sides of the waveguide.

28. A device according to claim 1, further comprising an additional doped region.
